(19) United States
(12) Patent Application Publication
(10) Pub. No.: US 2023/0207837 A1
(43) Pub. Date: Jun. 29, 2023

(54) BIPOLAR SURFACE ELEMENT

(71) Applicant: SGL CARBON SE, Wiesbaden (DE)

(72) Inventors: Thomas KOECK, Meitingen (DE); Werner LANGER, Meitingen (DE); Christina LOEFFLAD, Meitingen (DE)

(73) Assignee: SGL CARBON SE, Wiesbaden (DE)

(21) Appl. No.: 17/928,409

(22) PCT Filed: May 26, 2021
(86) PCT No.: PCT/EP2021/064102

§ 371 Date: Nov. 29, 2022

(30) Foreign Application Priority Data
May 29, 2020 (DE) 10 2020 206 774.0

(51) Int. Cl. H01M 8/0245; H01M 8/0234; H01M 8/0232; H01M 8/0239; H01M 8/18

(52) U.S. Cl. CPC H01M 8/0245; H01M 8/188; H01M 8/0232; H01M 8/0234; H01M 8/0239; H01M 2008/1095

(57) ABSTRACT

A bipolar flat element comprising a coating that contains expanded graphite and a binder, the coating being applied to at least one of the two primary surfaces of a flat, electrically conductive element.

The present invention relates to a bipolar flat element, to a fuel cell or redox flow battery having the bipolar flat element, and to a method for producing the bipolar flat element.

In connection with the production of capacitive sensors for soft systems, it has already been proposed to disperse expanded graphite in liquid media (White et al., Adv. Mater Technol. 2017, 2, 1700072). Soft systems are systems that can be stretched by more than 100%, such as elastomers. Such strains could not be captured, or could only be captured with difficulty, by conventional strain gauges. White et al. therefore indicate the need to provide highly deformable, electrically conductive materials whose moduli resemble those of non-traditional soft materials such as elastomers or biological tissues. Composite sensors are proposed whose electrical conductivity is provided by expanded intercalated graphite (EIG). Their manufacture involves ultrasonic treatment of EIG (obtained by means of intercalated sulphuric acid) in cyclohexane, mixing the EIG in cyclohexane with a specific silicone elastomer, and then casting conductive composite films such that a graphite content of 10 wt.% is obtained in the final composite. In certain tests, the proportion of graphite was increased to up to 20 wt.%, with no further increase in electrical conductivity being able to be achieved above 15%.

The present invention addresses other problems. The invention should be considered to be in the field of fuel cell technology and redox flow battery technology.

Fuel cells (FCs) and redox flow batteries (RFBs) contain bipolar plates. Their function is well known to those skilled in the field of fuel cell and redox flow battery technology, which is why their function will not be discussed further here. Bipolar plates can be very thin. Therefore, in connection with the present invention, reference is not made to bipolar plates, but to bipolar flat elements.

Redox reactions take place in FCs and RFBs, and can lead to corrosion of metallic bipolar flat elements. Mechanical damage occurs in graphite-based bipolar flat elements, with graphite particles being detached from the plate by the surrounding media. There is a desire to counteract these corrosion and disintegration problems in order to increase the service life of FCs, RFBs, or at least of the bipolar flat elements contained therein. In principle, it is conceivable to seal the bipolar flat elements by applying a coating. However, many coatings that are produced with conventional coating agents, such as polymer-based coating agents, have an electrical resistance that is far too high. Polymer-based coating agents frequently form almost completely insulating coatings. The application of such coatings to the surface of bipolar flat elements is not an option, since they can then no longer be used for their intended purpose.

Bipolar flat elements can have flow fields. A flow field is a channel structure formed on the surface of the bipolar flat element that promotes an even distribution of reactants over the entire surface. Such flow fields can be formed by deformation moulding, for example by press-fitting the flow field. It is conceivable to apply a coating that protects against corrosion and disintegration before the deformation (pre-coating), or after the deformation (post-coating). The problem with a pre-coating is that the coating has to be deformed as well. There must be no cracks in the coating. With post-coating, it is difficult to apply an even, sealed coating to the deformed, for example wavy, surface.

Briefly summarised, the following difficulties exist:
to produce a bipolar flat element in a simple manner;
at the same time, to produce it in such a way that it can be tailored to the requirements in specific FC or RFB systems, for example by forming flow field channel structures of almost any shape;
in the process, also to ensure a sufficiently low area-specific volume resistivity on the surface of the bipolar flat element that a high level of efficiency, i.e. energetically efficient operation of the FC or RFB, is possible; and
to protect the bipolar flat element from corrosion and disintegration in such a way that energetically efficient operation can be maintained over the long term.

The present invention addresses the problem of overcoming these difficulties by providing a bipolar flat element.

The object of the present invention is therefore to be seen as providing a bipolar flat element with which an FC or RFB can be operated energetically efficiently and over the long-term, which is also particularly easy to produce and can be tailored for a specific FC or RFB with little effort.

This object is achieved by a bipolar flat element comprising a coating containing expanded graphite and a binder, the coating being applied to at least one of the two primary surfaces of a flat, electrically conductive element.

Such a bipolar flat element allows electrical current to flow through the coating into the flat, electrically conductive element, and prevents or impedes the passage of gas or (corrosive) liquids through the coating. At the same time, the coating prevents the electrically conductive element from coming into direct contact with surrounding corrosive fluids. Consequently, even electrically conductive elements that are susceptible to corrosion can be used in corrosive media of FCs or RFBs. This is because the coating acts as an anti-corrosion coating without offering any significant resistance to the electrical current. At the same time, electrically conductive elements coated according to the invention, which would not be sufficiently gastight per se, can be sealed by the coating and thus used in FCs as bipolar flat elements.

The flat, electrically conductive element can be a foil or a plate. There are no restrictions with regard to the geometry of the foil or plate; it can be, for example, a rectangular or square, flat, electrically conductive element.

The flat, electrically conductive element can be made of any material that is known to a person skilled in the art as a material for bipolar plates or bipolar flat elements for FCs and/or RFBs.

The flat, electrically conductive element can be a metallic flat element. The term “metallic” includes metallic alloys. The metallic flat element can be a metal foil, a metal sheet or a metal plate, e.g., a steel foil, a stainless steel foil, a steel sheet, a stainless steel sheet, a steel plate or a stainless steel plate. The thickness of the metallic flat element can be 10 µm to 300 µm, for example 20 µm to 250 µm.

The invention makes the usual deformation of a flat metal element to form a flow field unnecessary. This is because the coating can have a flow field.

The flat, electrically conductive element can be a graphite-containing flat element.

The graphite-containing flat element may contain expanded graphite. This means that the graphite contained is wholly or partially present in the form of expanded graphite.

Flat elements containing expanded graphite are known, for example, as graphite foils. It is known that graphite foils can be produced by treating graphite with certain acids, thereby forming a graphite salt with acid anions intercalated between coatings of graphene. The graphite salt is then expanded by exposing it to high temperatures of, for example, 800° C. The expanded graphite obtained during the expansion is then pressed into the graphite foil. A method for producing graphite foils is described, for example, in EP 1 120 378 B1.

In general, the mass fraction of binder in the coating is higher than the mass fraction of binder in the flat element.

Compared to simply embossing flat elements made from expanded graphite, the invention offers surprising advantages.

In the conventional production of flat elements made of expanded graphite, a binder always has to be added to the expanded graphite, or the flat element has to be impregnated afterwards. This can also be done with a binder. This achieves the required gas tightness. However, the electrical properties deteriorate due to the binder distributed in the flat element. In addition, additional process steps are required to introduce the binder. The processability, adaptability and compressibility of the flat element are also unfavourably influenced by the binder.

In contrast, the invention with a flat element containing graphite leaves the properties of the flat element unchanged, and achieves improved electrical contacting capability.

The coating (in particular the binder contained therein) seals the primary surface (preferably both primary surfaces) of the flat element containing graphite, and thus ensures the required gas tightness. Because the binder is concentrated in the coating, the expanded graphite (substantially free of binder) of the graphite-containing flat element determines the processability, adaptability and compressibility of the bipolar flat element.

In a specific bipolar flat element according to the invention, the electrically conductive element is a flat element containing expanded graphite. One coating containing expanded graphite and a binder is applied to each of the two primary surfaces of the flat element containing expanded graphite. There is preferably a region substantially free of binder between the two coatings in the flat element. In the region substantially free of binder, the mass fraction of binder is less than 10 wt.%, preferably less than 6 wt.%, for example less than 2 wt.%.

The area-specific volume resistivity of the bipolar flat element can be, for example, at most 20 mΩ·cm², preferably at most 10 mΩ·cm².

According to the invention, the coating (for example, the coatings applied to the two primary surfaces) contains expanded graphite and a binder.

The thickness of the coating can be in the range from 5 to 500 µm, preferably in the range from 10 to 250 µm, for example in the range from 20 to 100 µm. If coatings are applied to both primary surfaces, this is preferably true for each coating. This has the effect that the overall resistance of the FC or RFB can be kept low, while at the same time providing corrosion resistance and gas tightness.

If the coating has a flow field, the thickness of the coating at the thinnest points of the coating, for example in the region of a channel of the flow field, can be in the range from 5 to 250 µm. At the thickest points of the coating, for example in the region between the channels or channel portions of the flow field, the coating is thicker and has a thickness in the range from 20 to 500 µm. In the case of certain bipolar flat elements according to the invention, the two coatings which are applied to the two primary surfaces can each have a flow field.

A coating having a flow field is obtained if the coating is treated with an embossing tool in order to emboss a flow field into the coating itself without deforming the metallic flat element itself. It can be assumed that this property is achieved by (almost) irreversible compression of the expanded graphite of the coating in the regions where the embossing tool is pushed down.

In bipolar flat elements according to the invention, the coating can be single-layer or multilayer. If a coating is applied to both primary surfaces of the flat, electrically conductive element, both coatings may be single-layer, both coatings may be multilayer, or one coating may be single-layer and the other coating may be multilayer.

In a multilayer coating, one layer can differ from another layer which abuts it in that the mass fraction of expanded graphite and/or the mass fraction of binder in one coating is different from that in the other coating. The mass fraction of binder is preferably higher in a layer closer to a primary surface of the flat, electrically conductive element than in a layer of the same coating farther from that primary surface. In general, the mass fraction of expanded graphite is then higher in the layer further away from this primary surface than in the layer of the same coating located closer to this primary surface of the metal element. It is assumed that the layer applied closer to the primary surface then produces a very good seal and corrosion resistance. The layer farther from the substrate or from the primary surface of the metal element has higher electrical conductivity due to its higher content of expanded graphite. In addition, the layer farther from the primary surface of the metal element is better able to mould a flow field because it has a higher proportion of compressible, expanded graphite.

Further subjects according to the invention are thus: A bipolar flat element having a multilayer coating, comprising a first and a second layer which abut each other, wherein both layers contain expanded graphite and a binder, wherein the mass fraction of binder in the first layer is higher than that in the second layer, and wherein the mass fraction of expanded graphite in the second layer is higher than in the first coating. A bipolar flat element comprising the multilayer coating on at least one of the two primary surfaces (preferably on both primary surfaces) of a flat metal element.

At least the second layer, which is farther from the primary surface of the flat, electrically conductive element, can be produced with a coating agent in which the ratio Q_{B} is at least 0.25. The first layer, which is closer to the primary surface of the flat, electrically conductive element, can also be produced with a coating agent according to the invention in which the ratio Q_{B} is at least 0.25. Care is then taken to ensure that the Q_{B} of the coating agent used to make the second layer is higher than the Q_{B} of the coating agent used to make the first layer. Alternatively, a coating agent not according to the invention, in which the ratio Q_{B} is less than 0.25, can also be used as the coating agent for the production of the first layer.

In at least one coating, regions comprising expanded graphite can have an average length parallel to the surfaces of the coating which is at least twice, in particular at least four times, preferably at least six times, for example at least eight times, as large as their average thickness. If the coating has a flow field, this average length versus average thickness relationship holds at least in a particularly thin region of the coating. The average thickness is measured orthogonally to the surfaces of the coating. If the coating agent described herein is applied to the flat, electrically conductive element, its thickness can be greatly reduced by compression. This can take place over the entire surface, or also only locally. For example, starting from a 200 µm-thick applied coating agent, a flow field with 100 µm-deep channels can be generated with an embossing tool. This results in strong compression of the regions of the coating comprising the expanded graphite, particularly in the region of the channels. The compression is substantially only orthogonal to the surfaces of the coating.

To determine the average length and thickness, a coating and the flat, electrically conductive element onto whose primary surface the coating is applied, is cut, and then an average length and an average thickness of the regions comprising the expanded graphite are determined microscopically in the cut surface. The cut surface can be formed by means of a wire saw and subsequent polishing. A focused ion beam (FIB) can also be used, in order not to destroy or falsify the coating structure during the preparation. The cut surface of the coating is then analysed microscopically.

In one coating, the ratio Qₛ calculated using the following equation:

$${\text{Q}}_{\text{S}} = \frac{{\text{m}}_{\text{SG}}}{{\text{m}}_{\text{SR}}}$$

where
m_{SG} stands for the mass of the expanded graphite contained in the coating, and
m_{SR} stands for the mass of the non-volatile coating components contained in the coating,
is at least 0.25. There is no upper limit to Qₛ, since it is precisely the case that, with relatively thick coatings, it is possible to produce gastight coatings that protect against corrosion, even with very high proportions of expanded graphite. Qₛ is preferably at most 0.97. Qₛ can in particular be in the range from 0.25 to 0.94, preferably in the range from 0.30 to 0.90, particularly preferably in the range from 0.30 to 0.80.

The coating contains a binder. Any binder is suitable with which the coating to be formed on the electrically conductive element in a sufficiently gastight manner, and/or in such a way that the flat, electrically conductive element is attacked more slowly by the surrounding corrosive medium than without the coating.

The binder can comprise, for example, thermoplastics and/or thermosets. Thermoplastics are easy to process. They are thermoformable. Coatings containing a thermoplastic can be shaped, for example, by hot calendering. If the coating contains a thermoset as a binder, this allows particularly high heat resistance. Bipolar flat elements having such coatings can be used, for example, in high-temperature PEM fuel cells, for example at a typical operating temperature of 180° C.

For example, the binder can comprise polypropylenes, polyethylenes, polyphenylene sulphides, fluoropolymers, phenolic resins, furan resins, epoxy resins, polyurethane resins, and/or polyester resins.

Fluoropolymers are preferred because of their particularly high corrosion resistance. Suitable fluoropolymers include polyvinylidene fluoride-hexafluoropropylene copolymers, polyvinylidene fluoride, ethylene-tetrafluoroethylene copolymers, tetrafluoroethylene-hexafluoropropylene copolymers, and polytetrafluoroethylenes. Polyvinylidene fluoride-hexafluoropropylene copolymers have proven to be particularly suitable fluoropolymers.

The binder may comprise silicon compounds comprising a moiety R, wherein
R stands for —Si(OR¹)(OR²)(OR³), —O—Si(OR¹)(OR²)(R³), or —O—Si(OR¹)(OR²)(OR³), and wherein
R¹, R² and R³ are moieties each bonded via a carbon atom.

R¹, R² and R³ preferably stands for hydrocarbyl, alkoxyhydrocarbyl or polyalkoxyhydrocarbyl, particularly preferably for alkyl, alkoxyalkyl or polyalkoxyhydrocarbyl, most preferably for C₁-C₁₈-alkyl, for example methyl, ethyl, propyl, propyl, butyl, hexyl, of which methyl is particularly preferred.

The silicon compound can be a polymeric silicon compound. As such, the silicon compound can comprise a polymer chain which has a plurality of moieties R.

A bipolar flat element according to the invention can be obtained by applying a coating agent to a flat, electrically conductive element, the coating agent containing expanded graphite and a binder.

The ratio Q_{B} of the mass of the expanded graphite present in the coating agent to the residual dry mass of the coating agent is preferably at least 0.25. The ratio Q_{B} can therefore be calculated using the following equation:

$${\text{Q}}_{\text{B}} = \frac{{\text{m}}_{\text{BG}}}{{\text{m}}_{\text{BR}}}$$

where
m_{BG} stands for the mass of the expanded graphite contained in the coating agent, and
m_{BR} stands for the residual dry mass of the coating agent.

The ratio Q_{B} can be at least 0.25. There is no upper limit to Q_{B}, since particularly with relatively thick coatings, coatings which seal and which protect against corrosion can be produced even with very high proportions of expanded graphite. Q_{B} is preferably at most 0.97. Q_{B} can in particular be in the range from 0.25 to 0.94, preferably in the range from 0.30 to 0.90, particularly preferably in the range from 0.30 to 0.80.

If the ratio Q_{B} does not result from the formulation according to which a coating agent according to the invention was produced, Q_{B} can be determined as follows:

Two samples of equal weight of a coating agent are taken.

All volatile components are removed from the first sample by evaporation. The temperature is kept as low as possible so that the contained binder does not begin to decompose. In particular, if relatively high-boiling but volatile diluents such as N,N-dimethylformamide (DMF) or N-methyl-2-pyrrolidone (NMP) are present in the coating agent, evaporation takes place under reduced pressure, for example, under fine vacuum. The complete evaporation of certain residual diluents can be accelerated by adding solvents (for example, n-heptane or ethylbenzene in the case of DMF) with which the particular diluent forms an azeotrope. The residual dry mass of the first sample is then determined by weighing. If it contains volatile binder components, the procedure for the first sample is as described, but the binder is cured beforehand or during evaporation. The residual dry mass m_{BR} is therefore the mass of the non-volatile coating agent components contained in the coating agent, which includes the binder and expanded graphite. Like the residual dry matter, the mass of the non-volatile coating components contained in the coating is also determined, with the coating initially being detached. The detachment can be mechanical or, for example, be done with a volatile solvent.

The expanded graphite is separated from the second sample by filtration; the expanded graphite filter cake is washed with solvent in order to free it from residual binder components, the expanded graphite thus obtained is dried, and its mass is determined m_{BG} by weighing.

Q_{B} is then calculated by dividing the mass of the expanded graphite m_{BG} separated from the second sample by the residual dry mass m_{BR} determined from the first sample.

The coating agent is suitable for forming the coating. The coating is electrically conductive. The specification “electrically conductive” relates to the electrical conductivity through the coating. This is because, with a bipolar flat element, it is important that there is electrical conductivity through the coating, so that the area-specific volume resistance of the bipolar flat element is sufficiently low for economical operation of the FC or RFB.

The coating agent contains expanded graphite. Expanded graphite is also referred to as exfoliated graphite or expandable graphite. The production of expanded graphite is described, for example, in U.S. Pat. No. 1,137,373 and U.S. Pat. No. 1,191,383. It is known that expanded graphite can be produced, for example, by treating graphite with certain acids, thereby forming a graphite salt with acid anions intercalated between layers of graphene. The graphite salt is then expanded by exposing it to high temperatures of from, for example, 800° C. For example, to produce expanded graphite having a vermiform structure, graphite such as natural graphite is usually mixed with an intercalate such as nitric acid or sulphuric acid and heat-treated at an elevated temperature of from, for example, 600° C. to 1200° C. (see DE10003927A1).

The expanded graphite contained in the coating agent is typically a partially mechanically exfoliated expanded graphite. “Partially mechanically exfoliated” means that the expanded vermiform structure is in a partially sheared form; partial shearing occurs, for example, by ultrasonic treatment of the vermiform structure. Only partial exfoliation occurs during the ultrasonic treatment, such that average particle sizes d50 occur in the micrometre range. In this case, there is no cleavage into individual graphene layers. However, it is possible to comminute the expanded vermiform structure in other ways. The expanded graphite contained in the coating agent should therefore not be limited to expanded graphite that has been partially mechanically exfoliated. The expanded graphite can be described in more detail, for example, via its average particle size, regardless of the way in which the average particle size can be manipulated.

The expanded graphite contained in the coating agent (for example, the partially mechanically exfoliated expanded graphite) is generally present in the form of particles. Their mean particle size d50 can be less than 50 µm, generally less than 30 µm, preferably less than 25 µm, particularly preferably less than 20 µm, for example less than 15 µm. The average particle size d50 is determined as described herein. Small particle sizes favour a high density of the coating that can be formed with the coating agent. If the average particle size d50 is small compared to the coating thickness, no (or virtually no) particle extends over the entire coating thickness. This increases both the corrosion resistance of a bipolar flat element coated with the coating agent and the mechanical strength of the coating. As a result, a high degree of freedom of design for flow fields, and at the same time a particularly high stability of the FC or RFB, is achieved. The desired particle size distribution can be set by ultrasound treatment, for example as shown below by way of example.

The mean particle sizes d50 given here are based on volume. The underlying particle size distributions (volume-based distribution sum Q₃ and distribution density q₃) are determined by laser diffraction according to ISO 13320-2009. A measuring device from Sympatec with a SUCELL dispersing unit and HELOS (H2295) sensor unit can be used for this purpose.

Certain coating agents according to the invention contain no particles whose diameter is more than 100 µm. It is particularly preferred if no particles are present whose diameter is more than 50 µm. This is effected by a person skilled in the art by forcing the coating agent through a grid with a mesh size of 100 µm or with a mesh size of 50 µm. If necessary, the coating agent is diluted beforehand so that it can easily pass through the grid. The (optionally diluted) coating agent on the grid is carefully stirred in order to break up agglomerates of smaller particles. If the coating agent complies with this upper particle size limit, it is stable and can be used in a variety of ways, without the narrow pores of, for example, sieves, nozzles, etc. – which certain coating devices, in particular coating devices for spraying on the coating agent, may have –clogging during processing.

The coating agent generally contains a diluent. Typically, at least a portion of the expanded graphite is dispersed in the diluent and at least a portion of the binder is dispersed or dissolved in the diluent. The effect of this is that a particularly homogeneous coating agent can be provided, which results in a particularly uniform distribution of graphite and binder in the coating that can be produced with the coating agent. Ultimately, this leads to a particularly reliable sealing of the flat, electrically conductive element, and thus to a longer service life for the FC and RFB. Further advantages consist in the fact that the viscosity can be adjusted to any degree by carefully selecting the proportion of diluent. The diluent can comprise water or organic solvents. Preferred organic solvents are polar aprotic solvents and aromatic solvents. Suitable polar aprotic solvents comprise ketones, N-alkylated organic amides, or N-alkylated organic ureas; with ketones or N-alkylated cyclic organic amides or N-alkylated cyclic organic ureas being preferred - for example, acetone, NMP and DMF. Suitable aromatic solvents comprise alkyl benzenes, especially mono- or di-alkyl benzenes, preferably toluene or xylenes, for example, toluene. Among the solvents mentioned, preference is given to those whose boiling point at 1013.25 mbar is below 250° C., in particular below 230° C., for example below 210° C. This promotes the drying process after the coating agent has been applied to the flat, electrically conductive element. When choosing the diluent and binder, a person skilled in the art can ensure that as much of the binder as possible dissolves in the diluent, so that a low-viscosity coating agent having high mass fractions of expanded graphite and binder can be obtained. The coating can then be carried out more easily, since less solvent is released during drying or curing.

The coating agent can contain 1 to 35 wt.%, preferably 2 to 25 wt.%, particularly preferably 2.5 to 20 wt.%, of expanded graphite. It was found that stable coating agents could be formulated within these limits, which at the same time could be applied very well to the primary surfaces of the flat, electrically conductive element. The coatings obtained in this way also had low electrical resistances, so that bipolar flat elements could be realised with very low area-specific volume resistances.

The coating agent preferably contains a dispersing agent. Depending on the diluent, different dispersing agents can be used which bring about steric stabilisation, static stabilisation, or electrosteric stabilisation of the coating agent. For the selection of suitable dispersing agents, a person skilled in the art will refer to the relevant specialist literature (see, for example, Artur Goldschmidt, Hans-Joachim Streitberger: BASF-Handbuch Lackiertechnik. Vincentz, Hanover 2002, ISBN 3-87870-324-4). The dispersing agent can be a cationic, anionic (for example, alcohol ethoxy sulphates [AES]), a zwitterionic surfactant, or a polymeric dispersing agent. Suitable polymeric dispersing agents are, for example, polyalkoxylated compounds (for example, Tween20 or Tween80) or polyvinylpyrrolidone (PVP). Suitable dispersing agents are also Byk-190 and Byk-2012. A particularly preferred dispersing agent is PVP. In the coating agent, the dispersing agent ensures that the coating agent is present as a particularly stable dispersion. Settling behaviour is improved, especially if water is used as the diluent. In addition, it was found that the viscosity of the coating agent can be adjusted via the amount of dispersing agent. Ultimately, a coating agent with a dispersing agent can be stored better and processed better. It has been shown that, with PVP, both a very low viscosity and a small particle size in laser diffraction can be achieved. With other dispersing agents, it was more difficult to adjust both parameters within an optimal range at the same time. The dispersing agent is also contained in the coating formed with the coating agent. In bipolar flat elements according to the invention, the coating can contain a dispersing agent, for example one of the dispersing agents mentioned here in connection with the coating agent.

The invention also relates to a fuel cell having a bipolar flat element according to the invention.

The invention also relates to a redox flow battery having a bipolar flat element according to the invention.

The invention also relates to a method for producing a bipolar flat element, in which a coating agent containing expanded graphite and a binder is applied to a flat, electrically conductive element. The coating agent can be applied in an initial coating agent thickness. The resulting composite coating is preferably calendered. During calendering, the thickness of the coating is reduced to at most half, preferably at most one quarter, for example at most one eighth of the initial thickness of the coating agent, at least in certain surface regions of the composite coating. A bipolar flat element in which the coating has a flow field can thus be produced in a particularly simple manner.

The invention is illustrated by the following examples and figures, without being restricted thereto.

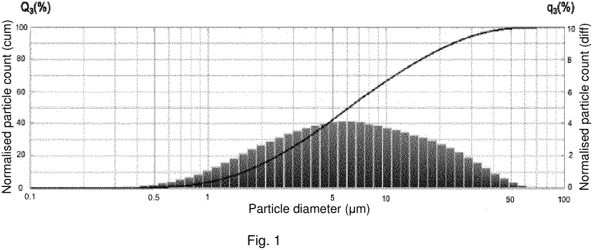

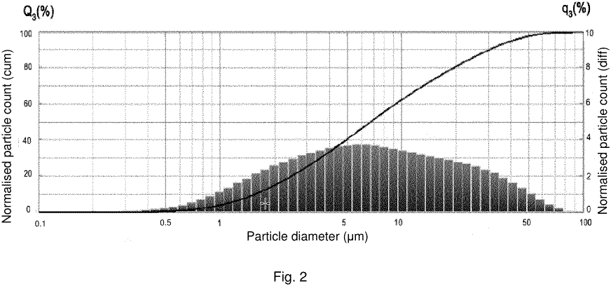

FIGS. 1 and 2 show particle size distributions of expanded graphite present in the form of particles.

### EXAMPLES

### Production of a Water-Based Graphite Dispersion

To produce a water-based graphite dispersion, 1.5 g of the dispersing agent polyvinylpyrrolidone (PVP) and 0.75 g of benzoic acid were dissolved in 1.4 L of the diluent, water. 232.5 g of expanded graphite were added to the solution and dispersed therein by means of ultrasound. The total energy input was about 4.5 kWh.

The particle size distribution of the water-based graphite dispersion was measured. The distribution is shown in FIG. 1.

### Production of a Premix

The water-based graphite dispersion was dried at 100° C. for 24 h. An easily (re)dispersible premix was obtained. This contained expanded graphite in the form of particles, and about 0.65 wt.% of the dispersing agent polyvinylpyrrolidone (PVP), and a small amount of benzoic acid.

### Production of a Coating Agent

A solution of polyvinylidene fluoride/hexafluoropropylene copolymer (PVDF/HFP), as a binder was produced in a diluent (acetone) (9 wt.% PVDF/HFP in acetone). The solution was added to the premix and the premix was redispersed in the solution by ultrasonic treatment for 15 minutes.

### Mass Fractions of the Coating Agent

PVDF/HFP: 7.8%
Expanded graphite: 5.2%
PVP: 0.09%
small amount of benzoic acid

The particle size distribution of the coating agent was measured. This is shown in FIG. 2. The particle size distributions shown in FIGS. 1 and 2 were determined using a Shimadzu SALD-7500 measuring apparatus with batch cell by laser diffraction, in accordance with ISO 13320-2009.

Steel sheets and foils were coated with the coating agent.

It was also possible to produce free-standing, thin graphite coatings. For this purpose, a separating coating was first applied to a metal foil. The coating agent was then applied to the metal foil and the resulting coating was then carefully peeled off.

### Production of a First Bipolar Flat Element According to the Invention

A coating agent containing 5.5 wt.% expanded graphite, 8 wt.% PVDF/HFP in the diluent acetone was prepared as described above. A metal foil having a thickness of 0.1 mm was coated on both sides with the coating agent, to a thickness of about 200 µm. The coated metal foil was then embossed at 200° C. using an embossing tool. As a result, an embossed flow field could be created in the applied coating without deforming the metal foil. The depth of the channels was about 100 µm.

### Production of a Second Bipolar Flat Element According to the Invention

A metal foil having a thickness of 0.1 mm was coated on both sides with the coating agent, to a thickness of about 100 µm. The coating agent used contained 5.5 wt.% of expanded graphite and 15 wt.% of PVDF/HFP in the diluent acetone. A second coating agent was then applied on both sides to a thickness of approx. 400 µm. The coating agent used contained 15 wt.% of expanded graphite and 8 wt.% of PVDF/HFP in the diluent acetone. The metal foil coated in multiple coatings in this way was then embossed at 200° C. with an embossing tool. As a result, an embossed flow field could be created in the applied, multilayer coating without deforming the metal foil. The depth of the channels was about 350 µm.

### Production of a Third Bipolar Flat Element According to the Invention

A graphite foil having a density of 0.3 g/cm³ and a thickness of 2 mm was coated with a coating agent. The coating thickness was 100 µm on both sides. The coating agent contained 5.5 wt.% expanded graphite, 8 wt.% PVDF/HFP, in the diluent acetone. It was made as described above. The graphite foil coated in this way was then embossed at 200° C. using an embossing tool. This made it possible to produce a sealed, embossed pattern.

Further tests showed that the coating agents can be calendered. A coating agent was applied to a metal foil with a doctor blade height of 300 µm. The coating was then compressed to a thickness of just 25 µm by calendering the composite coating. Metal and graphite foils can be coated on an industrial scale with the coating agents according to the invention in order to produce bipolar flat elements for fuel cells and redox flow batteries.

1-15. (canceled)

16. A bipolar flat element comprising a coating that comprises expanded graphite and a binder, wherein the coating is applied to at least one of two primary surfaces of a flat, electrically conductive element.

17. The bipolar flat element according to claim 16, wherein the flat, electrically conductive element is a metallic flat element.

18. The bipolar flat element according to claim 16, wherein the flat, electrically conductive element is a graphite-comprising flat element.

19. The bipolar flat element according to claim 18, wherein the flat element comprises expanded graphite.

20. The bipolar flat element according to claim 18, wherein a mass fraction of binder comprised in the coating is higher than a mass fraction of binder of the flat element.

21. The bipolar flat element according to claim 16, wherein an area-specific volume resistivity of the bipolar flat element is at most 20 mΩ•cm².

22. The bipolar flat element according to claim 16, wherein the binder comprises thermoplastics and/or thermosets.

23. The bipolar flat element according to claim 16, wherein the binder comprises a silicon compound comprising a moiety R, wherein
R stands for —Si(OR¹)(OR²)(OR³), —O—Si(OR¹)(OR²)(R³), or —O—Si(OR¹)(OR²)(OR³), wherein
R¹, R² and R³ are moieties each bonded via a carbon atom.

24. The bipolar flat element according to claim 16, wherein the coating comprises a dispersing agent.

25. The bipolar flat element according to claim 16, wherein the thickness of the coating is in the range of from 5 to 500 µm.

26. The bipolar flat element according to claim 16, wherein regions in the coating comprising the expanded graphite have an average length parallel to the surfaces of the coating that is at least twice as large as their average thickness.

27. The bipolar flat element according to claim 16, wherein, in the coating, the ratio Qs, which is calculated according to the following equation:
$${\text{Q}}_{\text{S}} = \frac{{\text{m}}_{\text{SG}}}{{\text{m}}_{\text{SR}}}$$
wherein
m_{SG} stands for the mass of the graphite comprised in the coating, and
m_{SR} stands for the mass of the non-volatile coating components comprised in the coating,
is at least 0.25.

28. The bipolar flat element according to claim 16, obtainable by applying a coating agent to a flat, electrically conductive element,
wherein the coating agent comprises expanded graphite and a binder.

29. A fuel cell or redox flow battery, having a bipolar flat element according to claim 16.

30. A method for producing a bipolar flat element, wherein a coating agent comprising expanded graphite and a binder is applied to a flat, electrically conductive element.

31. The bipolar flat element according to claim 19, wherein a mass fraction of binder comprised in the coating is higher than a mass fraction of binder of the flat element.
